(19) United States
(12) Patent Application Publication
(10) Pub. No.: US 2019/0297381 A1
(43) Pub. Date: Sep. 26, 2019

(54) ARTIFICIAL INTELLIGENCE DEVICE AND OPERATING METHOD THEREOF

(71) Applicant: LG ELECTRONICS INC., Seoul (KR)

(72) Inventors: Jaeyoun CHUNG, Seoul (KR); Dongwook KIM, Seoul (KR)

(73) Assignee: LG ELECTRONICS INC., Seoul (KR)

(21) Appl. No.: 16/361,064

(22) Filed: Mar. 21, 2019

Related U.S. Application Data
(60) Provisional application No. 62/645,814, filed on Mar. 21, 2018.

(51) Int. Cl. H04N 21/442; H04N 21/466; G06N 3/08; G06N 20/10

(52) U.S. Cl. CPC H04N 21/44218; H04N 21/4668; G06N 20/10; G06N 3/08; H04N 21/4666

(57) ABSTRACT

An artificial intelligence device according to an embodiment of the present disclosure may include a display, a memory configured for storing therein a boredom sensing model, and a processor configured for obtaining viewing situation data including times of channel changes and a channel watching duration for a predetermined duration, determining an emotional state of a viewer using the obtained viewing situation data and the boredom sensing model, and displaying a recommended content list on the display if the emotional state is determined to be a bored state.

Pursuant to 35 U.S.C. § 119(e), this application claims the benefit of U.S. Provisional Application No. 62/645,814, filed on Mar. 21, 2018, the contents of which are all hereby incorporated by reference herein in its entirety.

### BACKGROUND OF THE DISCLOSURE

### Field of the disclosure

The present disclosure relates to an artificial intelligence device, and more particularly, to an artificial intelligence device that automatically recognizes a user's watching status and recommends content adapted to the watching status.

### Related Art

As internet has become widespread, the number of content that a viewer may access has increased exponentially.

As the number of the viewer-accessible content increases, a technique for recommending content that the viewer would prefer in order to assist the viewer in selecting the content has been proposed.

For example, in such a recommendation technique, if the viewer uses the contents for a certain duration, a server that provides the contents or a TV that plays the contents may store a history of the contents that the viewer has used, and analyze the stored history of the contents usage to recommend the content that the viewer would prefer.

However, such content recommendation does not apply an emotional state of the viewer, and is provided only if a separate viewer request is received. Therefore, there was an inconvenience that the viewer should participate actively.

### SUMMARY OF THE DISCLOSURE

### Technical Purpose

A purpose of the present disclosure is to, if a viewer is watching an artificial intelligence device such as a TV, accurately grasp a time if the viewer gets bored and then to automatically provide content that may be of interest to the viewer.

Another purpose of the present disclosure is to provide a boredom sensing model customized and updated with taking into account a viewer feedback to a determined emotional state of the viewer.

### Technical Solution

An artificial intelligence device in accordance with the present disclosure may collect viewing situation data about an artificial intelligence device such as a TV, determine an emotional state of a viewer using the collected data and a trained model, and display a recommended content list to the viewer if the emotional state is determined to be a bored state.

An artificial intelligence device in accordance with the present disclosure may obtain updating training data with taking into account a viewer feedback to a recommended content list, and update a boredom sensing model using the obtained updating training data.

### Technical Effect

According to various embodiments of the present disclosure, if a viewer is watching a TV, a user's watching satisfaction may be improved by accurately grasping a time if the viewer gets bored, and then providing a recommended content list.

Further, according to various embodiments of the present disclosure, a recommended content list with high satisfaction level for each viewer may be provided by determining an emotional state of the viewer using a boredom sensing model updated based on a user's feedback.

Further, content use by the viewer may increase naturally due to the recommendation of the content list.

### BRIEF DESCRIPTION OF THE DRAWINGS

FIG. 1 is a block diagram illustrating a configuration of a terminal according to an embodiment of the present disclosure.

FIG. 2 is a block diagram illustrating a configuration of a training device of an artificial neural network according to an embodiment of the present disclosure.

FIG. 3 is a flow chart illustrating an operation of an artificial intelligence device according to an embodiment of the present disclosure.

FIG. 4 is an example of viewing situation data according to an embodiment of the present disclosure.

FIG. 5 is an example of training data used for training boredom sensing model according to an embodiment of the present disclosure.

FIG. 6 is a diagram of a process for obtaining content to be provided via a viewer-customized and recommended channel, according to an embodiment of the present disclosure.

FIGS. 7 and 8 illustrate examples of content list displayed as a viewer-customized and recommended channel is activated.

### DESCRIPTION OF EXEMPLARY EMBODIMENTS

Hereinafter, reference will now be made in detail to the embodiments described herein, examples of which are illustrated in the accompanying drawings. The same reference numbers will be used throughout the drawings to refer to the same or like parts, and repeated description of the same or like parts is omitted. The suffixes “module” and “unit” that are mentioned in the elements used in the following description are merely used individually or in combination for the purpose of simplifying the description of the present disclosure. Therefore, the suffix itself will not be used to differentiate the significance or function or the corresponding term. Further, in the description of the embodiment described herein, any specific description about functions or constructions that is well known in related arts will be omitted, if such a description is likely to obscure the gist of the embodiment described herein. Further, the accompanying drawings are only for the purpose of allowing the embodiment as disclosed herein to be understood easily, and are not to be construed as limiting the spirit of the present disclosure. The present disclosure is intended to cover not only the exemplary embodiments, but also various alternatives, modifications, equivalents and other embodiments that may be included within the spirit and scope of the present disclosure.

Although the terms first, second, etc. may be used herein to describe various components, these components should not be limited by these terms. These terms are only used to distinguish one component from another.

It will be understood that if a component is referred to as being “connected to”, or “coupled to” another component, it can be directly on, connected to, or coupled to the other component, or one or more intervening components may be present. In contrast, if a component is referred to as being “directly connected to” or “directly coupled to” another component or layer, there are no intervening components present.

An Artificial Intelligence (AI) is a field of a computer engineering and an information technology that studies a method for allowing a computer to do something that human intelligence may do such as thinking, learning, self-development, and the like. Thus, the Artificial Intelligence (AI) means allowing the computer to imitate an intelligent human behavior.

Further, the Artificial Intelligence does not exist by itself, and is directly or indirectly related to other fields of computer science. Particularly in modern age, there are many attempts to introduce the Artificial Intelligence in various fields in information technology for solving problems in the fields.

A machine learning is a field of the Artificial Intelligence that gives the computer an ability to learn without an explicit program.

Specifically, the machine learning is a technology for studying and constructing a system and an algorithm that learn based on empirical data, perform a prediction, and improve their own performances. The algorithms of the machine learning do not perform strictly defined static program commands, but rather takes a method for constructing a specific model to derive a prediction or a decision based on input data. Many machine learning algorithms have been developed for classifying data in the machine learning. A decision tree, a Bayesian network, a support vector machine (SVM), and an artificial neural network (ANN), and the like are considered as representative of the machine learning algorithm for the data classification.

The decision tree is an analysis method for tabulating a decision rule into a tree structure to perform the classification and the prediction.

The Bayesian network is a model representing probabilistic relationships (conditional independence) between multiple variables into a graph structure. The Bayesian network is suitable for a data mining via an unsupervised learning.

The support vector machine is a supervised learning model for a pattern recognition and a data analysis, and is mainly used for a classification and a regression.

The artificial neural network is a model of relationships between a principle of an action of biological neurons and a connection between the neurons. The artificial neural network is an information processing system in which a plurality of neurons called nodes or processing elements are connected in a layer structure.

The artificial neural network is a model used in the machine learning. The artificial neural network is a statistical learning algorithm that is inspired by a neural network in biology (especially brain among an animal's central nervous system) in cognitive science and the machine learning.

Specifically, the artificial neural network may refer to a model in which an artificial neuron (node) as a network between synapses changes a connection strength between the synapses via a learning and thus has a problem-solving ability.

The term “artificial neural network” may be used interchangeably with the term “neural network”.

The artificial neural network may contain a plurality of layers, each of which may contain the plurality of neurons. The artificial neural network may also contain the synapse that connects the neuron to the neuron.

The artificial neural network may generally be defined by following three factors: (1) a connection pattern between the neurons in different layer; (2) a training process for updating a weight of the connection; and (3) an activation function that takes a weighted sum over an input received from a previous layer to generate an output value.

The artificial neural network may include network models such as a DNN (Deep Neural Network), an RNN (Recurrent Neural Network), a BRDNN (Bidirectional Recurrent Deep Neural Network), an MLP (Multilayer Perceptron) and a CNN (Convolutional Neural Network), but is not limited thereto.

The Artificial neural networks are classified into single-layer neural networks and multi-layer neural networks based on the number of the layers.

The typical single-layer neural networks are constituted by an input layer and an output layer.

Further, the typical multi-layer neural networks are constituted by an input layer, a hidden layer, and an output layer.

The input layer is a layer that accepts external data. Further, the number of neurons in the input layer is equal to the number of input variables. The hidden layer is located between the input layer and the output layer. Further, the hidden layer receives a signal from the input layer, extracts a feature, and delivers the extracted feature to the output layer. The input signal between the neurons is multiplied by respective connection strengths between 0 and 1, then summed. If this sum is greater than a threshold of the neuron, the neuron is activated and outputted as an output value through an activation function.

Further, a deep neural network including the plurality of hidden layers between the input and output layers may be a representative artificial neural network implementing a deep learning, which is one type of the machine learning technology.

The artificial neural network may be trained using training data. In this connection, the training may refer to a process for determining a parameter of the artificial neural network using the training data in order to achieve a purpose such as classifying, regressing, or clustering the input data. A representative example of the parameter of the artificial neural network is the weight applied to the synapse, and a bias applied to the neuron.

The artificial network trained with the training data may classify or cluster the input data based on a pattern of the input data.

Further, herein, the artificial neural network trained using the training data may be referred to as a trained model.

The following describes a method for training the artificial neural network.

The learning method of the artificial neural network may be largely classified into a supervised learning, an unsupervised learning, a semi-supervised learning, and a reinforcement learning.

The supervised learning is a method of the machine learning to derive a function from the training data.

Further, among such derived functions, outputting consecutive values may be referred to as the regression, and predicting and outputting a class of an input vector may be referred to as the classification.

In the supervised learning, the artificial neural network learns on condition that labels for respective training data are given.

In this connection, the label may refer to a correct answer (or a result value) that the artificial neural network must infer if the training data is input to the artificial neural network.

Herein, the correct answer (or the result value) that the artificial neural network must infer if the training data is input is referred to as the label or labeling data.

Further, herein, setting the labels for the training data in order for the training of the artificial neural network is referred to as labeling the labeling data to the training data.

In this case, the training data and the label corresponding to the training data may constitute one training set, and may be input in a form of the training set to the artificial neural network.

Further, the training data represents a plurality of features, and labeling the label to the training data may mean that the label is set based on the feature of the training data. In this case, the training data may represent a feature of an input object in a form of a vector.

The artificial neural network may derive a function for a relationship between the training data and the labeling data using the training data and the labeling data. Further, the artificial neural network may determine (optimize) the parameter of the artificial neural network based on an evaluation of the derived function.

The unsupervised learning is a type of the machine learning, and no labels are given for the training data.

Specifically, the unsupervised learning may be a learning method for learning the artificial neural network to find the pattern in the training data itself, rather than in the relation between the training data and the label corresponding to the training data, and to classify the data.

Examples of the unsupervised learning may include a clustering or an independent component analysis.

An example of the artificial neural network using the unsupervised learning may include a Generative Adversarial Network (GAN) and an autoencoder (AE).

The Generative Adversarial Network is a machine learning method in which two different artificial intelligence, a generator and a discriminator, competes with each other to improve performances.

In this case, the generator is a model for creating new data. The generator may generate the new data based on original data.

In addition, the discriminator is a model that recognizes patterns of the data. The discriminator may discriminate authenticity of the new data generated by the generator based on the original data.

In addition, the generator may receive and learn data as discriminated by the discriminator, and the discriminator may receive and learn data as not discriminated from the generator. Thus, the generator may evolve to deceive the discriminator as much as possible, and to distinguish well the original data of the discriminator and the data generated by the generator.

An autoencoder is a neural network that aims to reproduce an input itself as an output.

The autoencoder contains an input layer, a hidden layer, and an output layer. Further, input data passes through the input layer and enters the hidden layer.

In this case, since the number of nodes in the hidden layer is smaller than the number of nodes in the input layer, a dimension of the data is reduced. Therefore, a compression or encoding is performed.

Further, the data output from the hidden layer enters the output layer. In this case, since the number of nodes in the output layer is larger than the number of nodes in the hidden layer, the dimension of the data is increased. Thus, a decompression or decoding is performed.

Further, the autoencoder adjusts a connection strength of the neurons via training such that the input data is represented as hidden layer data. In the hidden layer, information is represented using the number of neurons smaller than that of the input layer. In this connection, the input data being be reproduced as the output may mean that the hidden pattern being found from the input data may allow the hidden layer to be represented.

The semi-supervised learning is a type of the machine learning, which may refer to a training method using both training data that the label is given and training data that the label is not given.

The semi-supervised learning technique includes a technique for inferring the label of the training data that the label is not given, and learning with the inferred label. This technique may be useful if the labeling costs are high.

The reinforcement learning is a theory that, if an environment in which an agent may determine what action should take every moment is given, without data, the best way may be found with an experience.

The reinforcement learning may be performed primarily by a Markov Decision Process (MDP).

In the Markov decision process, firstly, an environment in which information necessary for the agent to take a next action is configured is provided, then, secondly, how the agent takes action in that environment is defined. Then, thirdly, an action for which the agent receives a reward or penalty is defined, and, fourthly, an optimal policy is derived via iterative experience until a subsequent reward level reaches its peak.

A structure of the artificial neural network is determined by a model configuration, an activation function, a loss function, a cost function, a learning algorithm, an optimization algorithm, or the like. Further, in the artificial neural network, a hyperparameter may be predetermined before the learning, then a model parameter may be determined through the learning thereby determining a content.

For example, factors for determining the structure of the artificial neural network may include the number of hidden layers, the number of hidden nodes contained in each hidden layer, an input feature vector, an object feature vector, and the like.

The hyperparameter includes various parameters such as an initial value of the model parameter, and the like that should be initially determined for the learning. In addition, the model parameter includes various parameters to be determined through the learning.

For example, the hyperparameter may include an initial value of a weight between nodes, an initial value of a bias between nodes, a mini-batch size, a repetition number of learning, a learning rate, and the like. In addition, the model parameter may include a weight between nodes, a bias between nodes, and the like.

The loss function may be used as an index (reference) to determine an optimal model parameter in the learning process of the artificial neural network. In the artificial neural network, the learning refers to manipulating the model parameters to reduce the loss function. A purpose of the learning may be to determine the model parameter that minimizes the loss function.

Mean Squared Error (MSE) or Cross Entropy Error (CEE) may be mainly used as the loss function, but the present disclosure is not limited thereto.

The Cross Entropy Error may be used if a correct answer label is one-hot encoded. The one-hot encoding is an encoding method in which a correct answer label value is set to 1 for neurons corresponding to a correct answer, and a correct answer label value is set to 0 for neurons that are not the correct answer.

In the machine learning or the deep learning, a learning optimization algorithm may be used for minimizing the loss function. The learning optimization algorithm includes a Gradient Descent (GD), a Stochastic Gradient Descent (SGD), a Momentum, a Nesterov Accelerate Gradient (NAG), an Adagrad, an AdaDelta, an RMSProp, an Adam, a Nadam, and the like.

The Gradient Descent is a technique to adjust the model parameter in a direction of decreasing a loss function value in consideration of a slope of the loss function in a present state.

An adjust direction of the model parameter may be referred to as a step direction, and an adjust size may be referred to as a step size.

In this connection, the step size may refer to the learning rate.

The Gradient Descent may obtain a slope by partially differentiating the loss function with each of the model parameters, and change and update the model parameters by the learning rate in accordance with an obtained slope.

The Stochastic Gradient Descent is a technique that divides the training data into the mini-batches, and performs the gradient descent for each mini-batch to increase a frequency of the gradient descent.

The Adagrad, the AdaDelta, and the RMSProp are techniques that adjust the step size in the SGD to improve an optimization accuracy. In the SGD, the Momentum and the NAG are techniques that adjust the step direction to improve the optimization accuracy. The Adam is a technique that combines the Momentum and the RMSProp to adjust the step size and the step direction thereby improving the optimization accuracy. The Nadam is a technique that combines the NAG and the RMSProp to adjust the step size and the step direction thereby improving the optimization accuracy.

Learning speed and accuracy of the artificial neural network depends not only on the structure of the artificial neural network and a type of the training optimization algorithm but also on the hyperparameter. Therefore, in order to obtain a good learning model, it is important not only to determine the proper structure of the artificial neural network and learning algorithm but also to determine the proper hyperparameter.

Typically, Hyperparameter may be experimentally set to various values. An optimal value thereof that provides stable training speed and accuracy if training the artificial neural network using the experimentally set hyperparameter may be selected.

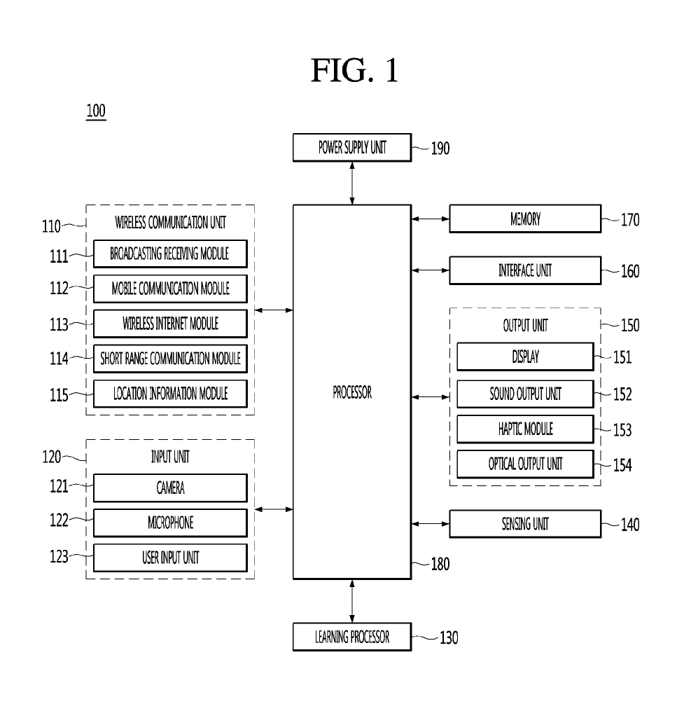

FIG. 1 is a block diagram illustrating a configuration of a terminal 100 according to an embodiment of the present disclosure.

A terminal 100 may be implemented as a stationary device, a mobile device, and the like such as a mobile phone, a projector, a smart phone, a laptop computer, a terminal for a digital broadcasting, a personal digital assistant (PDA), a portable multimedia player (PMP), a navigation, a slate PC, a tablet PC, an ultrabook, a wearable device (e.g., a smartwatch, a smart glass, a head mounted display (HMD)), a Set Top Box (STB), a DMB receiver, a radio, a washing machine, a refrigerator, a desktop computer, a Digital Signage.

That is, the terminal 100 may be implemented as various home appliances used in the home, and may be applied to fixed or mobile robots.

The terminal 100 may perform a voice agent function. The voice agent may be a program that recognizes a voice of the viewer and outputs a voice response corresponding to the recognized voice of the viewer.

With reference to FIG. 1, the terminal 100 may include a wireless communication unit 110, an input unit 120, a learning processor 130, a sensing unit 140, an output unit 150, an interface unit 160, a memory 170, a processor 180 and a power supply unit 190.

The training model may be mounted into the terminal 100.

Further, the training model may be implemented as hardware, software, or a combination of the hardware and the software. If a part or all of the training model is implemented as the software, at least one instruction that forms the training model may be stored in the memory 170.

The wireless communication unit 110 may include at least one of a broadcasting receiving module 111, a mobile communication module 112, a wireless internet module 113, a short range communication module 114 and a location information module 115.

The broadcasting receiving module 111 receives a broadcasting signal and/or broadcasting related information from an external broadcasting managing server via a broadcasting channel.

The mobile communication module 112 transmits and receives a wireless signal to and from at least one of a base station, an external terminal, and a server on a mobile communication network constructed based on technical standards or communication methods for a mobile communication (e.g., a Global System for Mobile communication (GSM), a Code Division Multi Access (CDMA), a Code Division Multi Access 2000 (CDMA2000), an Enhanced Voice-Data Optimized or Enhanced Voice-Data Only (EV-DO), a Wideband CDMA (WCDMA), a High Speed Downlink Packet Access (HSDPA), a Long Term Evolution (LTE), a Long Term Evolution-Advanced (LTE-A), and the like).

The wireless internet module 113 is a module for a wireless internet connection, and may be mounted internal or external to the terminal 100. The wireless internet module 113 is configured to transmit and receive the wireless signal in a communication network based on wireless internet technologies.

The wireless internet technologies includes, for example, a wireless LAN (WLAN), a wireless fidelity (Wi-Fi), a Wi-Fi (Wireless Fidelity) Direct, a Digital Living Network Alliance (DLNA), a Wireless Broadband (WiBro), a World Interoperability for Microwave Access (WiMAX), a High Speed Downlink Packet Access (HSDPA), a High Speed Uplink Packet Access (HSUPA), a Long Term Evolution (LTE), a Long Term Evolution-Advanced (LTE-A), and the like.

The short range communication module 114 is for a short range communication, and may support the short range communication using at least one technology of a Bluetooth™, a Radio Frequency Identification (RFID), an Infrared Data Association (IrDA), an Ultra Wideband (UWB), a ZigBee, a Near Field Communication (NFC), a Wireless-Fidelity (Wi-Fi), a Wi-Fi Direct, a Wireless Universal Serial Bus (Wireless USB).

The location information module 115 is a module for acquiring a location (or a current location) of the mobile terminal. As a representative example thereof, there is a Global Positioning System (GPS) module or a Wireless Fidelity (WiFi) module. For example, if using the GPS module, the terminal may acquire the location thereof using a signal from a GPS satellite.

The input unit 120 may include a camera 121 for an image signal input, a microphone 122 for receiving an audio signal, and a user input unit 123 for receiving information from the viewer.

Voice data or image data collected from the input unit 120 may be analyzed and processed by a user's control command.

The input unit 120 may acquire input data, and the like to be used if acquiring an output using the training data for the model training and the trained model.

The input unit 120 may acquire raw input data. In this case, the processor 180 or the learning processor 130 may preprocess the acquired data to generate training data that may be input to the model to be trained or to generate preprocessed input data.

In this connection, the preprocessing for the input data may refer to extracting an input feature from the input data.

The input unit 120 is for inputting the image information (or signal), the audio information (or signal), the data, or information input from the viewer. The terminal 100 may include the one or the plurality of cameras 121 for inputting the image information.

The camera 121 processes, in a videotelephony mode or a capturing mode, image frames of still images, moving images, or the like obtained by an image sensor. The processed image frame may be displayed on a display 151 or stored in the memory 170.

The microphone 122 processes an external sound signal into electrical voice data. The processed voice data may be utilized variously based on a function being performed (or an application program being executed) in the terminal 100. Further, the microphone 122 may be implemented with various noise elimination algorithms for eliminating a noise generated in receiving the external sound signal.

The user input unit 123 is for receiving the information from the viewer. If the information is input through the user input unit 123, the processor 180 may control an operation of the terminal 100 to correspond to the input information.

The user input unit 123 may include mechanical input means (or a mechanical key, e.g., a button, a dome switch, a jog wheel, a jog switch, and the like located at a front/rear face or side face of the terminal 100) and touch-type input means. As an example, the touch-type input means may include a virtual key, a soft key, or a visual key displayed on a touch screen through software processing, or a touch key disposed on a portion other than the touch screen.

The learning processor 130 learns the model constituted by the artificial neural network using the training data.

Specifically, the learning processor 130 may allow the artificial neural network to repeatedly learn using the various learning techniques described above to determine the optimal model parameters of the artificial neural network.

Herein, the artificial neural network in which the parameters are determined by training using the training data may be referred to as the trained model.

In this connection, the training model may be used to infer a result value for new input data rather than the training data.

The learning processor 130 may be configured to receive, classify, store, and output information to be used for a data mining, a data analysis, an intelligent decision making, and the machine learning algorithm and technique.

The learning processor 130 may include at least one memory unit configured to store therein data received, detected, sensed, generated, predetermined, or otherwise output by another component, device, terminal, or an apparatus that communicates with the terminal.

The learning processor 130 may include a memory integrated or implemented in the terminal. In some embodiments, the learning processor 130 may be implemented using the memory 170.

Alternatively, or additionally, the learning processor 130 may be implemented using a memory associated with the terminal, such as an external memory directly coupled to the terminal or a memory maintained at a server communicating with the terminal.

In another embodiment, the learning processor 130 may be implemented using memory maintained in a cloud computing environment, or another remote memory accessible by a terminal via the communication scheme as that of the network.

The learning processor 130 may be generally configured to store data in one or more databases for identifying, indexing, categorizing, manipulating, storing, retrieving, and outputting the data for using in the supervised or unsupervised learning, the data mining, a predictive analysis, or other machines. In this connection, the database may be implemented using the memory 230 of the training device 200, a memory maintained in a cloud computing environment, or another remote memory accessible by a terminal via the communication scheme as that of the network.

The information stored in the learning processor 130 may be used by the processor 180 or one or more different controllers of the terminal using any of a variety of different types of data analysis algorithm and machine learning algorithm.

Examples of such algorithm include a K-nearest neighbor system, a fuzzy logic (e.g., a possibility theory), a neural network, a Boltzmann machine, a vector quantization, a pulse neural network, a support vector machine, a maximum margin classifier, a hill climbing, an inductive logic system Bayesian network, (e.g., a finite state machine, a millimachine, a Moore finite state machine), a classifier tree (e.g., a perceptron tree, a support vector tree, a Markov tree, a decision tree forest, a random forest), reading model and system, an artificial fusion, a sensor fusion, an image fusion, a reinforcement learning, an augmented reality, a pattern recognition, an automated plan, and the like.

The processor 180 may determine or predict at least one executable operation of the terminal based on the information determined or generated using the data analysis and machine learning algorithms To this end, the processor 180 may request, retrieve, receive, or utilize the data of the learning processor 130, and may control the terminal to perform a predicted operation or an operation determined to be desirable among the at least one executable operation.

The processor 180 may perform various functions to implement an intelligent emulation (that is, a knowledge-based system, a inferring system, and a knowledge acquisition system). This may be applied to various types of systems (e.g., a fuzzy logic system) including an adaptive system, the machine learning system, the artificial neural network, and the like.

The processor 180 may include submodules that enable operations accompanying voice and natural language voice processing such as an I/O processing module, an environmental condition module, a Speech to Text (STT) processing module, a natural language processing module, a task flow processing module and a service processing module.

Each of these sub-modules may have access to at least one system or data and model in the terminal, or a subset or a superset thereof. Further, each of these sub-modules may provide a variety of functions, including a vocabulary index, viewer data, a task flow model, a service model, and an automatic speech recognition (ASR) system.

In another embodiment, the processor 180 or other aspects of the terminal may be implemented with the submodule, system, or data and model.

In some embodiments, based on the data of the learning processor 130, the processor 180 may be configured to detect and sense requirements based on a context condition or an intention of the viewer represented as a viewer input or a nature language input.

The processor 180 may actively derive and acquire information necessary to fully determine the requirements based on the context condition or the intention of the viewer. For example, the processor 180 may analyze historical data including historical input and output, a pattern matching, an unambiguous word, an input intention, and the like to actively derive the information necessary to determine the requirements.

The processor 180 may determine a task flow for performing a function responding to the requirement based on the context condition or the intention of the viewer.

The processor 180 may be configured to collect, detect, extract, sense, and/or receive a signal or data used in the data analysis and machine learning operations through at least one sensing component in the terminal in order to collect information for processing and storing at the learning processor 130.

The information collection may include sensing the information via the sensor, extracting the information stored in the memory 170, or receiving the information from another terminal, entity or external storage device via the communication means.

The processor 180 may collect usage history information from the terminal, and store the usage history information in the memory 170.

The processor 180 may use the stored usage history information and a predictive modeling to determine the best match for performing a particular function.

The processor 180 may receive or sense the surrounding information or other information via the sensing unit 140.

The processor 180 may receive the broadcasting signal and/or the broadcasting related information, the wireless signal, and the wireless data through the wireless communication unit 110.

The processor 180 may receive the image information (or the corresponding signal), the audio information (or the corresponding signal), the data, or the viewer input information from the input unit 120.

The processor 180 may collect the information in real time, process or classify the information (e.g., a knowledge graph, a command policy, a customized database, a dialog engine, etc.), and store the processed information in the memory 170 or the learning processor 130.

If the operation of the terminal is determined based on the data analysis and machine learning algorithms and techniques, the processor 180 may control the components of the terminal to perform the determined operation. In addition, the processor 180 may control the terminal based on a control command to perform the determined operation.

If the specific operation is performed, the processor 180 may analyze the history information indicating the execution of the specific operation through the data analysis and machine learning algorithms and techniques, and update previously learned information based on the analyzed information.

Therefore, the processor 180, along with the learning processor 130, may improve an accuracy of future performance of the data analysis and machine learning algorithms and techniques based on the updated information.

The sensing unit 140 may include at least one sensor for sensing at least one of information in the mobile terminal, information about surrounding environment of the mobile terminal, and viewer information.

For example, the sensing unit 140 may include at least one of a proximity sensor, an illumination sensor, a touch sensor, an acceleration sensor, a magnetic sensor, a gravity sensor (G-sensor), a gyroscope sensor, a motion sensor, an RGB sensor, an infrared sensor (IR sensor), a finger scan sensor, an ultrasonic sensor, an optical sensor (e.g., see the camera 121), a microphone (see microphone 122), a battery gauge, an environment sensor (e.g., a barometer, a hygrometer, a thermometer, a radiation sensor, a heat sensor, a gas sensor, etc.), and a chemical sensor (e.g. an electronic nose, a healthcare sensor, a biometric sensor, etc.). Further, the terminal disclosed herein may combine and utilize information sensed by at least two of the sensors.

The output unit 150 is for generating an output related to a sense of sight, a sense of hearing, a sense of touch, or the like. The output unit 150 may include at least one of a display 151, a sound output unit 152, a haptic module 153, and an optical output unit 154.

The display 151 displays (outputs) information processed in the terminal 100. For example, the display 151 may display execution screen information of an application program running on the terminal 100 or UI (User Interface) and GUI (Graphic viewer Interface) information based on the execution screen information.

The display 151 may form a mutual layer structure with the touch sensor, or may be integrally formed with the touch sensor to realize a touch screen. This touch screen may function as the user input unit 123 that provides the input interface between the terminal 100 and the viewer, and at the same time, provides an output interface between the terminal 100 and the viewer.

The sound output unit 152 may output audio data received from the wireless communication unit 110 or stored in the memory 170 in a calling signal reception mode, a calling mode or a recording mode, a voice recognition mode, a broadcasting reception mode, and the like.

The sound output unit 152 may include at least one of a receiver, a speaker, and a buzzer.

The haptic module 153 generates various haptic effects that the viewer may feel. A representative example of the haptic effect generated by the haptic module 153 may be a vibration.

The optical output unit 154 outputs a signal for notifying an occurrence of an event using a light of a light source of the terminal 100. Examples of the event that occur at the terminal 100 may include a message reception, a calling signal reception, a missed call, an alarm, a schedule notification, an email reception, an information reception via an application, and the like.

The interface unit 160 serves as a path with various types of the external devices connected to the terminal 100. This interface unit 160 may include at least one of a wired/wireless headset port, an external charger port, a wired/wireless data port, a memory card port, a port for connecting a device having an identification module, an audio I/O (Input/Output) port, video I/O (Input/Output) port, and an earphone port. In the terminal 100, corresponding to the connection of the external device to the interface unit 160, a proper control with respect to the connected external device may be performed.

Further, the identification module is a chip that stores various information for authenticating an usage right of the terminal 100. The identification module may include a viewer identity module (UIM), a subscriber identity module (SIM), a universal subscriber identity module (USIM), and the like. A device equipped with the identification module (hereinafter referred to as an “identification device”) may be manufactured in a form of the smart card. Therefore, the identification device may be connected to the terminal 100 via the interface unit 160.

The memory 170 stores therein data supporting various functions of the terminal 100.

The memory 170 may store therein a plurality of application programs or applications running on the terminal 100, data for the operation of the terminal 100, instructions, and data for the operation of the learning processor 130 (e.g., at least one algorithm information for the machine learning, and the like).

The memory 170 may store therein the model trained by the learning processor 130 or the training device 200.

In this connection, the memory 170 may store therein the trained model into a plurality of versions based on a learning time, a learning progression degree, or the like, if necessary.

In this connection, the memory 170 may store therein the input data acquired from the input unit 120, the training data used for the model training, the training history of the model, and the like.

In this connection, the input data stored in the memory 170 may be raw input data itself as well as properly processed data for the model training.

In addition to the operations associated with the application program, the processor 180 typically controls an overall operation of the terminal 100. The processor 180 may process a signal, data, information, etc., input or output through the components discussed above, or may drive an application program stored in the memory 170 to provide or process information or a function suitable for the viewer.

Further, the processor 180 may control at least some of the components illustrated in FIG. 1 to drive the application program stored in the memory 170. Further, the processor 180 may operate at least two of the components included in the terminal 100 in combination with each other for driving the application program.

Further, as discussed above, the processor 180 controls the operations associated with the application programs, and typically the overall operation of the terminal 100. For example, the processor 180 may activate or deactivate a lock state that restricts input of the user's control command to the application if a state of the terminal satisfies a determined condition.

The power supply unit 190 receives external power and internal power under the control of the processor 180 to supply power to each component of the terminal 100. This power supply unit 190 includes a battery, which may be an internal battery or a replaceable battery.

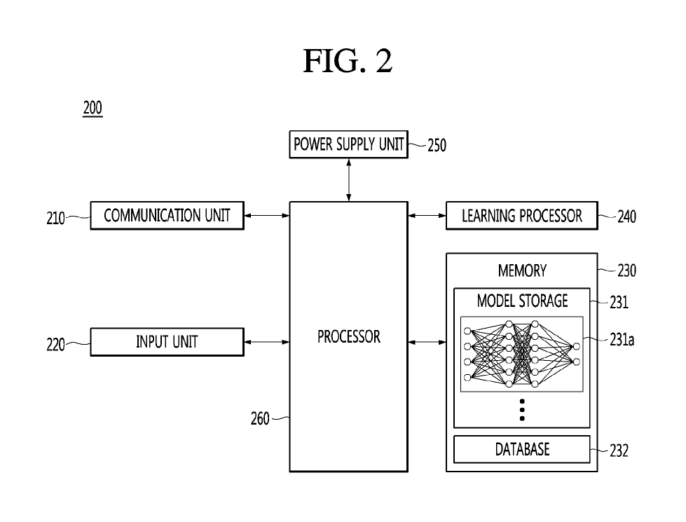

FIG. 2 is a block diagram illustrating a configuration of a training device 200 of an artificial neural network according to an embodiment of the present disclosure.

The training device 200 may be a separate device or a server outside the terminal 100, and may perform the same function as the learning processor 130 of the terminal 100.

That is, the training device 200 may be configured to receive, classify, store and output information to be used for the data mining, data analysis, intelligent decision making and machine learning algorithms In this connection, the machine learning algorithm may include a deep learning algorithm.

The training device 200 may communicate with the at least one terminal 100, and analyze or learn the data on behalf of or by helping the terminal 100. In this connection, the helping another device may refer to a distribution of computing power through a distributed processing.

The training device 200 of the artificial neural network is a device for learning the artificial neural network, and may usually mean a server. The training device 200 may be refer to as a training device or a learning server.

In particular, the training device 200 may be implemented as a single server, a plurality of server sets, a cloud server, or combinations thereof.

That is, the training device 200 may constitute a plurality of training device sets (or the cloud server). The at least one training device 200 in the training device set may analyze or learn the data through the distributed processing to derive the result.

The training device 200 may transmit the model trained through the machine learning or the deep learning to the terminal 100 periodically or upon a request.

With reference to FIG. 2, the training device 200 may include a communication unit 210, an input unit 220, a memory 230, a learning processor 240, a power supply unit 250, and a processor 260.

The communication unit 210 may correspond to a configuration including the wireless communication unit 110 and the interface unit 160 of FIG. 1. That is, the communication Unit 210 may transmit or receive the data to or from another device via a wired or wireless communication or an interface.

The input unit 220 corresponds to the input unit 120 of FIG. 1. In addition, the input unit 220 may acquire the data by receiving the data through the communication unit 210.

The input unit 220 may use training data for the model training and a trained model to acquire input data, and the like for obtaining an output.

The input unit 220 may acquire raw input data. In this case, the processor 260 may preprocess the acquired data to generate the training data or preprocessed input data to be input for the model training.

In this connection, the preprocessing for the input data performed in the input unit 220 may refer to extracting an input feature from the input data.

The memory 230 corresponds to the memory 170 of FIG. 1.

The memory 230 may include model storage 231, a database 232, and the like.

The model storage 231 stores a model that is being trained or that is trained (or an artificial neural network 231a) through the learning processor 240. In addition, if the model is updated via training, the model storage 231 stores the updated model.

In this connection, the model storage 231 may store the trained model into a plurality of versions based on a learning time, a learning progression degree, or the like, if necessary.

The artificial neural network 231a illustrated in FIG. 2 is only one example of an artificial neural network including a plurality of hidden layers, and the artificial neural network of the present disclosure is not limited thereto.

The artificial neural network 231a may be implemented as hardware, software, or a combination of the hardware and the software. If a part or all of the artificial neural network 231a is implemented as the software, at least one instruction that forms the artificial neural network 231a may be stored in the memory 230.

The database 232 may store the input data acquired from the input unit 220, the training data used for the model training, the training history of the model, and the like.

The input data stored in the database 232 may be raw input data itself as well as properly processed data for the model training.

The learning processor 240 corresponds to the learning processor 130 of FIG. 1.

The learning processor 240 may use the training data or training set to allow the artificial neural network 231a to train (or learn).

The learning processor 240 may directly acquire the data obtained by preprocessing the input data acquired through the input unit 220 by the processor 260 to train the artificial neural network 231a. Alternatively, the learning processor 240 may acquire the preprocessed input data stored in the database 232 to train the artificial neural network 231a.

Specifically, the learning processor 240 may allow the artificial neural network 231a to repeatedly learn using the various learning techniques described above to determine optimal model parameters of the artificial neural network 231a.

Herein, the artificial neural network in which the parameters are determined by the learning using the training data may be referred to as the training model or the trained model.

In this connection, the training model may be used to infer a result value in a state of being mounted in the training device 200. Alternatively, the training model may be transmitted to and mounted in another device such as the terminal 100 via the communication unit 210.

Further, if the training model is updated, the updated training model may be transmitted to and mounted in another device such as the terminal 100 via the communication unit 210.

The power supply unit 250 corresponds to the power supply unit 190 of FIG. 1.

Overlapping descriptions of the components corresponding to each other will be omitted.

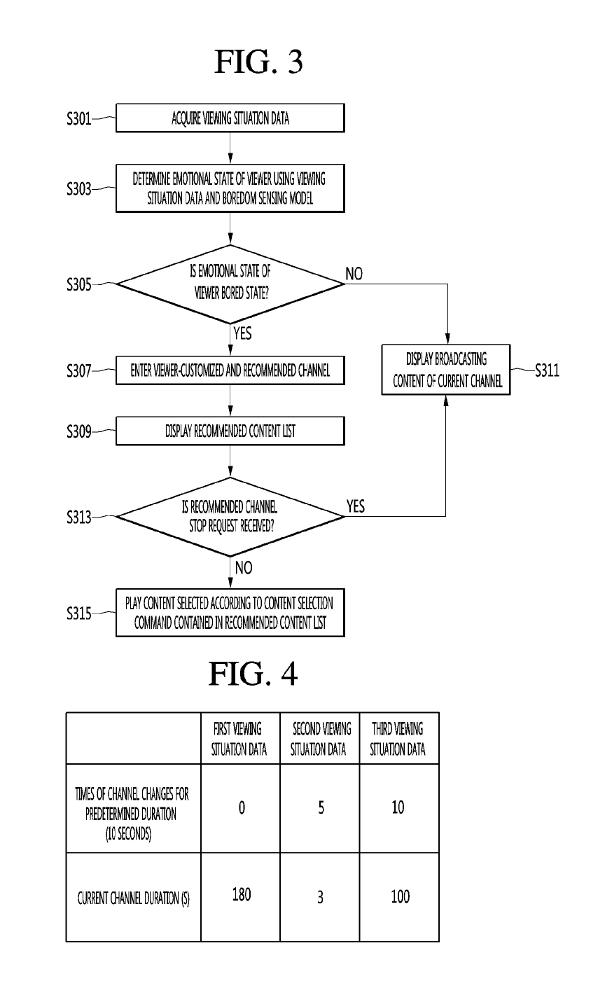

FIG. 3 is a flow chart illustrating an operation of an artificial intelligence device according to an embodiment of the present disclosure.

In the following embodiment, the artificial intelligence device 100 is assumed to be a display device such as a smart TV, an IPTV, or the like.

The Processor 180 of the Artificial Intelligence Device 100 Acquires Viewing Situation Data About the Viewer (S301).

The viewing situation data may include at least one of the times of channel changes and a channel watching duration for a predetermined duration.

The processor 180 may obtain the times of channel changes using times of channel change requests for a predetermined duration received from a remote control device (not shown) that may control the operation of the artificial intelligence device 100.

In this connection, the predetermined duration may be 10 seconds, but this is only an example.

The processor 180 may receive the channel change request from the remote control device via the short range communication module 114.

The watching duration for each channel may indicate the watching duration of a current channel or a broadcasting content provided in the past.

The processor 180 may acquire the duration during which one channel is maintained, without changing the channel, as the watching duration for each channel.

FIG. 4 is an example of viewing situation data according to an embodiment of the present disclosure.

FIG. 4 shows an example of the viewing situation data in which each column may represent data for an independent state.

The viewing situation data of FIG. 4 is only an example, and a format thereof, too, is only an example. Therefore, the format of the viewing situation data may be changed according to the embodiment, and accordingly, data items included may be different. For example, the viewing situation data may further include information about the watching duration of a previous channel

In another example, the viewing situation data may further include the number of yawning of the viewer analyzed from a viewer image captured for a predetermined duration through the camera 121 of the artificial intelligence device 100.

Again, FIG. 3 is to be explained.

The Processor 180 Determines an Emotional State of the Viewer Using the Viewing Situation Data and a Boredom Sensing Model (S303).

The user's emotional state may be either a bored state indicating that the viewer is bored, or a not-bored state indicating that the viewer is not bored.

In one embodiment, the boredom sensing model may refer to an artificial neural network based model trained by the machine learning algorithm or the deep learning algorithm.

The boredom sensing model may be a customized model trained for each viewer using the artificial intelligence device 100.

That is, the boredom sensing model may be trained and generated separately for each artificial intelligence device in the house.

The boredom sensing model may be stored in the memory 170 of the artificial intelligence device 100.

In one example, the boredom sensing model stored in the memory 170 may be a model trained through the learning processor 130 of the artificial intelligence device 100.

In another example, the boredom sensing model may be trained through the learning processor 240 of the training device 200, received from the training device 200 via the wireless communication unit 110, and stored.

The processor 180 may periodically request update information of the boredom sensing model to the training device 200 based on a predetermined update time, a viewer request, or a request of the training device 200.

The processor 180 may receive the update information from the training device 200 in response to the request of the boredom sensing model update information, and store the received update information in the memory 170.

The processor 180 may use the boredom sensing model updated based on the update information to determine whether the viewer is in the bored state.

The boredom sensing model may be a model constituted by an artificial neural network trained to infer the bored state of the viewer representing a feature (or an output feature) using training data in a same format as the viewing situation data as input data.

The boredom sensing model may learn through the supervised learning. Specifically, the training data used in the training of the boredom sensing model may be labeled with the user's emotional state (the bored state or the not-bored state of the viewer). The boredom sensing model may learn using the labeled training data.

The training data may include information about the user's watching status and the user's emotional state that is suitable for the watching status.

The boredom sensing model may learn aiming to accurately infer the labeled emotional state from information about a given viewing status.

A loss function (cost function) of the boredom sensing model may be expressed as a square mean of a difference between a label of the emotional state of the viewer corresponding to each training data and the emotional state of the viewer inferred from each training data.

Further, in the boredom sensing model, model parameters included in the artificial neural network may be determined to minimize the cost function through the learning.

That is, the boredom sensing model is the artificial neural network model that is supervised and trained using the training data including the training viewing situation data and the labeled user's emotional state corresponding thereto.

If an input feature vector is extracted from the viewing situation data for the learning, and input, a determination result of the user's emotional state is output as an object feature vector. Then, the boredom sensing model may learn to minimize the loss function corresponding to a difference between the output object feature vector and the labeled emotional state.

In one example, a object feature of the boredom sensing model may be constituted by an output layer of a single node representing the user's emotional state. The object feature may have a value of “1” if representing the bored state, and may have a value of “0” if representing the not-bored state. In this case, the output layer of the boredom sensing model may use sigmoid, hyperbolic tangent (tanh), and the like as an activation function.

In another example, the object feature of the boredom sensing model may be constituted by an output layer of two output nodes representing the user's emotional state. Each output node may indicate whether the viewer is in the bored state or in the not-bored state.

That is, the object feature (object feature vector) may be constituted by whether the viewer is in the bored state or in the not-bored state. The object feature may have “(1,0)” as a value thereof if representing the bored state, and may have “(0,1)” as a value thereof if representing the not-bored state. In this case, the output layer of the boredom sensing model may use a soft max as the activation function.

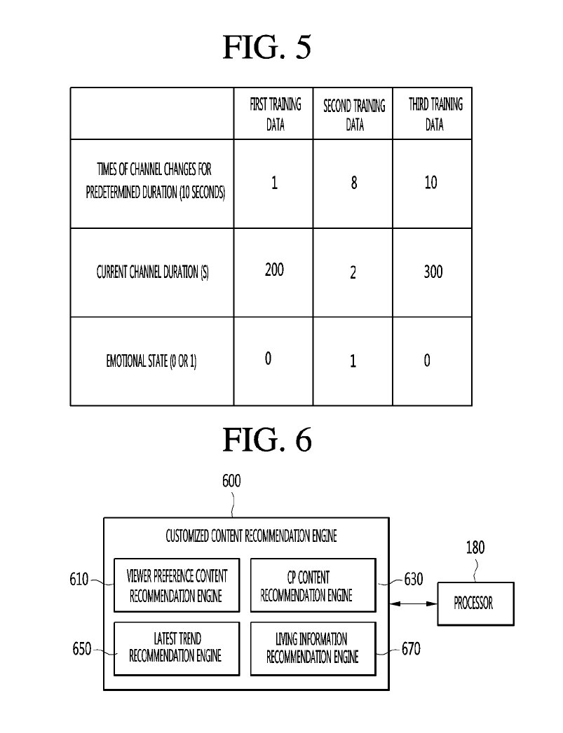

FIG. 5 is an example of training data used for training boredom sensing model according to an embodiment of the present disclosure.

The processor 180 may obtain the object feature corresponding to the emotional state of the viewer using the viewing situation data as input data from the boredom sensing model, and determine the emotional state of the viewer based on the obtained object feature.

For example, the processor 180 may input the viewing situation data to the boredom sensing model, and obtain a scalar between 0 and 1 for the user's emotional state, or a two-dimensional vector with each element that is a scalar between 0 and 1 as an output.

The processor 180 may determine whether the user's emotional state is the bored state or the not-bored state using the obtained two-dimensional vector.

Again, FIG. 3 will be explained.

If the Emotional State of the Viewer is Determined to be the Bored State (S305), the Processor 180 Changes a Current Channel to a Viewer-Customized and Recommended Channel (S307).

If the user's emotional state is determined to be the bored state, processor 180 may change the current channel to the viewer-customized and recommended channel

The viewer-customized and recommended channel may be a channel for providing acquired contents based on a user's preference, content provider's recommendation information, the latest trend information, and living information.

The processor 180 may obtain content extracted from electronic program guides (EPG) based on the user's watching history as content based on the user's preference.

The processor 180 may obtain content of the content provider that the viewer is able to watch.

The processor 180 may acquire content with a high number of views from a video portal, a social network service, and the like.

The processor 180 may obtain useful living information such as news, weather, stocks, and the like, and notification or status information of a smart device of the viewer as content to be provided on the viewer-customized and recommended channel

FIG. 6 is a diagram of a process for obtaining content to be provided via a viewer-customized and recommended channel, according to an embodiment of the present disclosure.

The content to be provided on the viewer-customized and recommended channel may be obtained in advance.

If the user's emotional state is the bored state, the processor 180 may request, to a customized content recommendation engine 600, content list to be provided on the viewer-customized and recommended channel

The customized content recommendation engine 600 may generate the content list in response to the processor 180, and deliver the generated content list to the processor 180.

The customized content recommendation engine 600 may be a chip separate from the processor 180, but is not limited thereto. The engine 600 may be included in the processor 180.

The customized content recommendation engine 600 may include a viewer like content recommendation engine 610, a CP content recommendation engine 630, a latest trend recommendation engine 650, and a living information recommendation engine 670.

The viewer like content recommendation engine 610 may be an engine that extracts the viewer like content from the EPG based on the user's watching history.

The user's watching history may contain a broadcasting content that is frequently watched by the viewer or has a large watching duration collected during a certain duration.

The viewer like content recommendation engine 610 may extract the same genre as the collected broadcasting content from the EPG and obtain the extracted content as a like content.

The CP content recommendation engine 630 may obtain the content recommended by the content provider.

The CP content recommendation engine 630 may obtain the content recommended by the content provider from content provider's server through the wireless internet module 113.

The latest trend recommendation engine 650 may obtain content with the highest number of views in the video portal, the social network service, or the like.

The latest trend recommendation engine 650 may access a portal web site or a web site of the social network service through the wireless internet module 113 to obtain the corresponding content.

The living information recommendation engine 670 may obtain the useful living information such as news, weather, stocks, and the like, and the notification or status information of the artificial intelligence device (or smart device) of the viewer as a recommendable content.

The content list may contain the at least one content provided from the engines included in the customized content recommendation engine 600.

Again, FIG. 3 will be explained.

The Processor 180 Displays the Recommended Content List on the Display 151 as the Viewer-Customized and Recommended Channel is Activated (S309).

The processor 180 may display on the display 151 the content list obtained from the customized content recommendation engine 600.

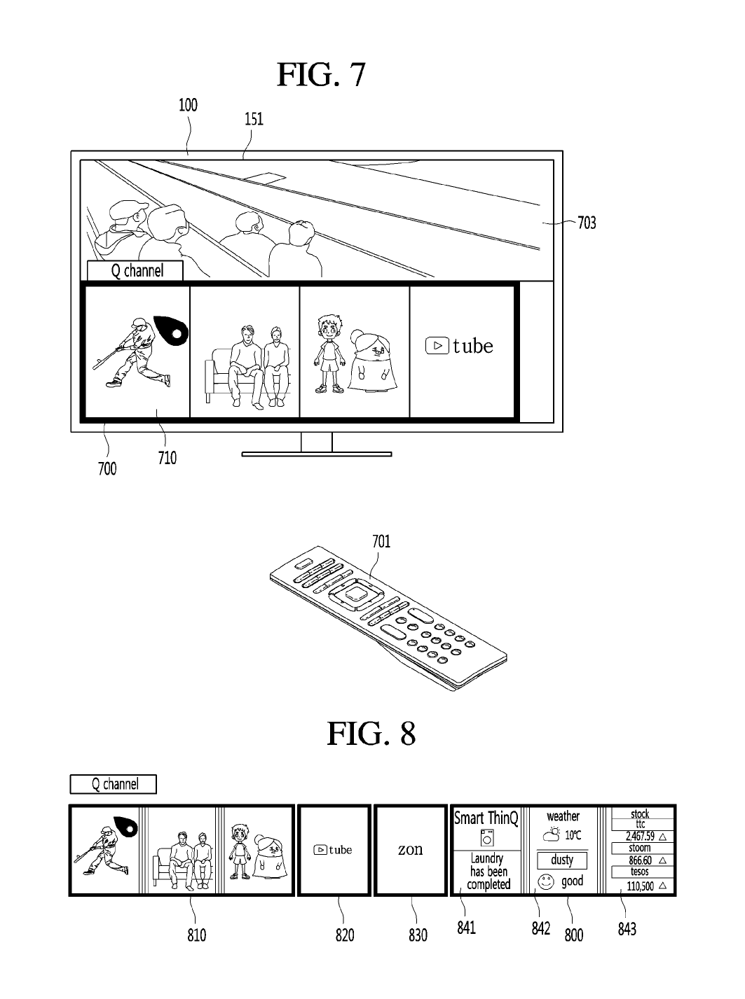

FIGS. 7 and 8 illustrate examples of content list displayed as a viewer-customized and recommended channel is activated.

In FIGS. 7 and 8, the processor 180 assumes that the user's emotional state is determined to be the bored state.

With reference to FIG. 7, the display 151 of the artificial intelligence device 100 may display content list 700 as a viewer-customized and recommended channel is activated.

In one example, the processor 180 may superimpose and display the content list 700 on a broadcasting content image 703 of a current channel.

In another example, the processor 180 may deactivate the current channel, that is the broadcasting content image 703 is not displayed, and display only the content list 700. That is, the processor 180 may change the current channel to the recommended channel if the emotional state of the viewer is determined to be the bored state.

The content list 700 may contain the content obtained from a customized content recommendation engine 600.

The viewer may select content 710 contained in the content list 700 through a remote control device 701 that may control an operation of the artificial intelligence device 100, and watch the selected content 710.

Thus, the artificial intelligence device 100 according to the embodiment of the present disclosure may recommend the content actively at the time if the viewer is bored to resolve the boredom of the viewer. That is, a viewer experience based on the content recommendation is improved.

With reference to FIG. 8, content list 800 provided as the viewer-customized and recommended channel is activated is illustrated.

The content list 800 may contain content 810 recommended based on the viewer preference, content 820 recommended based on the latest trend, content 830 recommended by the CP, and content 840 recommended based on the living information.

Specifically, the content 840 recommended based on the living information may contain notification information 841 received from another artificial intelligent device that may be connected to the artificial intelligence device 100.

For example, if the other artificial intelligence device is a laundry processing device, the artificial intelligence device 100 may perform a wireless communication with the other artificial intelligence device via the short range communication module 114, and receive notification information 841 from the other artificial intelligence device.

The content 840 recommended based on the living information may further contain information 842 about weather and fine dust and information 843 about stock.

If the viewer watches TV, the viewer may get recommendation of various kinds of content such as the viewer-customized and recommended content list such that the boredom may be solved.

Further, a service provider providing the content may induce utilization of the content of the TV viewer through the recommended content list.

Again, FIG. 3 will be explained.

If the Emotional State of the Viewer is Determined Not to be the Bored State (S307), the Processor 180 Displays the Broadcasting Content of the Current Channel (S311).

That is, the processor 180 may display the broadcasting content 703 of the current channel without displaying the content list 700, in FIG. 7.

If Receiving a Recommended Channel Stop Request for Deactivating the Recommended Channel (S313), the Processor 180 Displays the Broadcasting Content of the Channel Being Watched (S311).

On the Other Hand, if the Recommended Channel Stop Request is Not Received (S313), the Processor 180 Plays Content Selected According to a Command to Select Content Contained in the Recommended Content List (S315).

That is, the processor 180 may receive a command to select content contained in the content list illustrated in FIG. 7 or 8 from the remote control device, and play the selected content on the display 151 based on the received command.

The boredom sensing model described above may be updated based on a feedback of the viewer.

The processor 180 may obtain feedback information about the provided content list through the input unit 120.

Specifically, the processor 180 may receive a feedback voice of <the recommended content list is not good> about the content list.

In another example, if the recommended channel stop request is received from the remote control device within one second after displaying the recommended content list, the processor 180 may obtain this stop request as the feedback information.

In this connection, the obtained feedback information may be used to update the boredom sensing model.

Further, the collected feedback information may be used to update only a boredom sensing model customized to a current object.

For example, if updating the boredom sensing model corresponding to the viewer as the current object, feedback information collected only from the corresponding artificial intelligence device 100 or the corresponding viewer may be used.

In this connection, the collected feedback information may be used as labeling information for the user's emotional state.

In this connection, the processor 180 may store the feedback information and the viewing situation data corresponding to the feedback information in the memory 170 as a pair.

In this connection, the stored pair of the viewing situation data and the feedback information may be used to update the boredom sensing model through the learning processor 130 or the learning processor 240 of the training device 200 of the artificial neural network.

As such, the boredom sensing model updated based on user's satisfaction or preference may be used to determine the user's emotional state such that a customized content with high satisfaction level for each viewer may be provided.

The present disclosure described above may be implemented as computer readable code on a medium on which a program is recorded. The computer readable medium includes any type of recording device that stores data that may be read by a computer system. Examples of the computer readable medium include a hard disk drive (HDD), a solid state disk (SSD), a silicon disk drive (SDD), a ROM, a RAM, a CD-ROM, a magnetic tape, a floppy disk, an optical data storage device, and the like. Further, the computer may include the processor 180 of the terminal.

What is claimed is:

1. An artificial intelligence device comprising:
a display;
a memory configured to store a boredom sensing model; and
a processor configured to:
obtain viewing situation data including times of channel changes and a channel watching duration for a predetermined duration;
determine an emotional state of a viewer using the obtained viewing situation data and the boredom sensing model; and
display a recommended content list on the display if the emotional state is determined to be a bored state.

2. The artificial intelligence device of claim 1, wherein the processor is configured to:
change a current channel to a recommended channel if the determined emotional state is the bored state; and
display the recommended content list on the changed recommended channel on the display.

3. The artificial intelligence device of claim 2, wherein the recommended content list includes at least one of:
content extracted from an electronic program guide based on user preferences;
content recommended by a content provider;
latest trend content extracted from a website; and
living information content.

4. The artificial intelligence device of claim 1, wherein the boredom sensing model includes an artificial neural network model trained using a machine learning algorithm or a deep learning algorithm, and
wherein the boredom sensing model is trained by a training device of an external artificial neural network or by a learning processor for training the artificial neural network.

5. The artificial intelligence device of claim 4, wherein the boredom sensing model is trained in a supervised manner using training viewing situation data, and using training data including an emotional state labeled in the training viewing situation data.

6. The artificial intelligence device of claim 5, wherein if an input feature vector is extracted from the training viewing situation data, and is inputted to the boredom sensing model, the boredom sensing model infers and output an object feature vector as the emotional state,
wherein the boredom sensing model is trained to minimize a loss function corresponding to a difference between the output emotional state and the labeled emotional state.

7. The artificial intelligence device of claim 6, wherein the processor is configured to:
obtain a feedback of a user to the displaying of the recommended content list;
generate updating training data including the obtained feedback and viewing situation data at a time when the feedback is obtained; and
store the updating training data in the memory or transmit the updating training data to the training device.

8. The artificial intelligence device of claim 7, wherein the boredom sensing model is further trained by additionally applying the updating training data to the boredom sensing model.

9. The artificial intelligence device of claim 4, wherein the boredom sensing model is individually trained and customized per each user.

10. The artificial intelligence device of claim 1, further comprising a short range communication module configured to receive a command from a remote control device,
wherein the processor is configured to:
obtain, as the times of channel changes, receiving times of a channel change command from the remote control device for the predetermined duration, and
obtain a watching duration of a current channel as the channel watching duration.

11. A method for operating an artificial intelligence device, the method comprising:
obtaining viewing situation data including times of channel changes and a channel watching duration for a predetermined duration;
determining an emotional state of a viewer using the obtained viewing situation data and the boredom sensing model; and
displaying a recommended content list on the display if the emotional state is determined to be a bored state.

12. The method of claim 11, wherein the displaying of the recommended content list includes:
changing a current channel to a recommended channel if the determined emotional state is the bored state; and
displaying the recommended content list on the changed recommended channel on the display.

13. The method of claim 11, wherein the boredom sensing model includes an artificial neural network model trained using a machine learning algorithm or a deep learning algorithm, and
wherein the boredom sensing model is trained by a training device of an external artificial neural network or by a learning processor for training the artificial neural network.

14. The method of claim 13, wherein the boredom sensing model is trained in a supervised manner using training viewing situation data and using training data including an emotional state labeled in the training viewing situation data.

15. A recording medium having a program thereon for performing a method for operating an artificial intelligence device, the method comprising:
obtaining viewing situation data including times of channel changes and a channel watching duration for a predetermined duration;
determining an emotional state of a viewer using the obtained viewing situation data and the boredom sensing model; and
displaying a recommended content list on the display if the emotional state is determined to be a bored state.
